(19) United States
(12) Patent Application Publication
(10) Pub. No.: US 2010/0302263 A1
(43) Pub. Date: Dec. 2, 2010

(54) INFORMATION PROCESSING APPARATUS AND SWITCHING CONTROL METHOD FOR AUDIO OUTPUT DESTINATION

(75) Inventor: Nobuyuki Kurihara, Oume-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/789,340

(22) Filed: May 27, 2010

(30) Foreign Application Priority Data
May 27, 2009 (JP) 2009-127891

(51) Int. Cl. G06T 15/00; G06F 17/00

(52) U.S. Cl. 345/522; 700/94

(57) ABSTRACT

An apparatus including: a speaker; a sound controller for generating audio data; an audio driver for controlling the sound controller; and a connection terminal configured to attach a cable for simultaneously transmitting video data and audio data to an external monitor. When it is determined that the external monitor has an audio output function, the audio driver switches an output destination of the audio data to the connection terminal. When it is determined that the external monitor does not have the audio output function, the audio driver switches the output destination of the audio data to the speaker.

This application is based upon and claims the benefit of priority from Japanese Patent Application No. 2009-127891, filed on May 27, 2009, the entire contents of which are incorporated herein by reference.

### BACKGROUND

1. Field

One embodiment of the invention relates to a switching control technique for an audio output destination suitable for an information processing apparatus such as a notebook personal computer (PC) connectable to a DisplayPort compatible monitor or the like.

2. Description of the Related Art

In recent years, battery-operable and easily portable notebook PCs are spreading widely. In general, such a notebook PC is provided with a liquid crystal display (LCD) as well as a connector used for connecting an external monitor having a large screen. Thus, a user can utilize various modes like: images are displayed on the built-in LCD when the user is out of the office or home, while images are displayed on an external monitor when in the office or home; and images are displayed on the built-in LCD at the time of work of document preparation, information retrieval, or the like, while images are displayed on an external monitor at the time of watching a video such as a movie.

Further, recently, even a monitor having an audio output function is available. Then, as a mechanism of improving the convenience, for example, a method has been proposed that in linkage with switching of the video output destination from a built-in LCD to an external monitor, the audio output destination is automatically switched from a built-in speaker to a connection terminal (connected to the external monitor) (see, for example, JP-A-2009-9321).

An example of a monitor having an audio output function is a DisplayPort compatible monitor. In such a DisplayPort compatible monitor, the audio output function is optional.

Thus, in a case that an external monitor not having an audio output function is connected, when the video output destination is switched to this external monitor and, in linkage with this, the audio output destination is also switched to the external monitor, a situation arises that audio is not outputted from anywhere.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing a schematic configuration and a utilization mode of an information processing apparatus according to an embodiment of the invention;

FIG. 2 is a functional block diagram showing a video output and an audio output of an information processing apparatus according to the embodiment; and

FIG. 3 is a flowchart showing an operation procedure of audio output control executed by an information processing apparatus according to the embodiment.

### DETAILED DESCRIPTION

Various embodiments according to the invention will be described hereinafter with reference to the accompanying drawings. In general, according to one embodiment of the invention, an information processing apparatus includes: a speaker; a sound controller configured to generate audio data to be output through the speaker; an audio driver configured to control the sound controller; a connection terminal configured to attach a cable for simultaneously transmitting video data and audio data to an external monitor; and an identification acquisition module configured to acquire identification information from the external monitor when the external monitor is connected to the connection terminal, the identification information including information as to whether the external monitor includes an audio output function; wherein the audio driver determines whether the external monitor has the audio output function based on the identification information; when the audio driver determines that the external monitor has the audio output function, the audio driver switches an output destination of the audio data to the connection terminal; and when the audio driver determines that the external monitor does not have the audio output function, the audio driver switches the output destination of the audio data to the speaker.

An embodiment is described below with reference to the drawings.

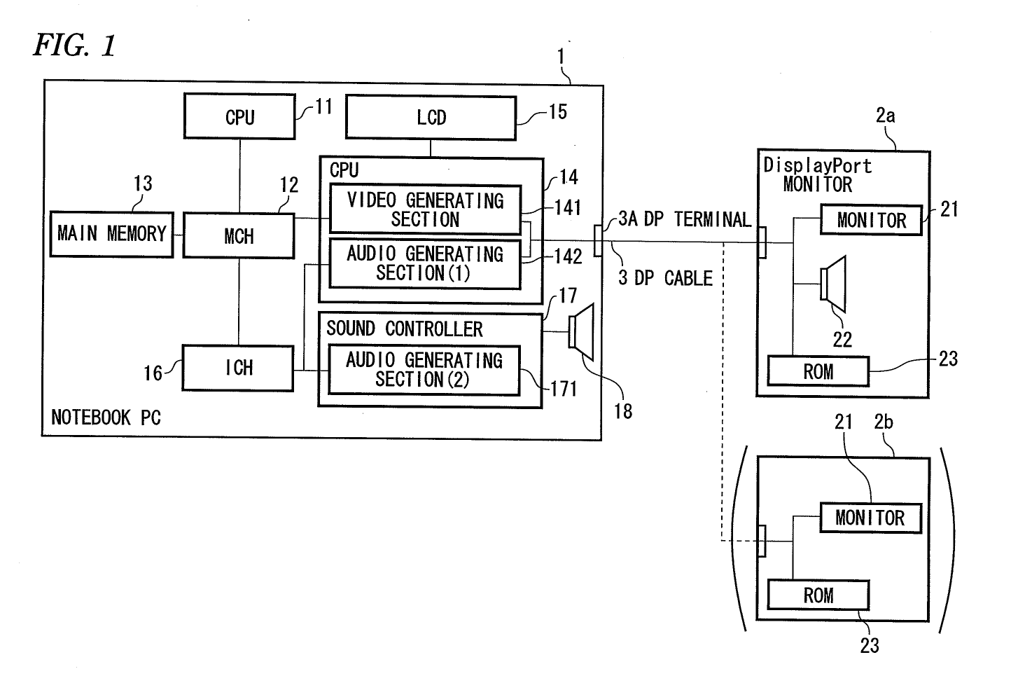

FIG. 1 is a diagram showing a schematic configuration and a utilization mode of an information processing apparatus according to the present embodiment. This information processing apparatus is implemented by a notebook PC 1.

As shown in FIG. 1, the notebook PC 1 has a central processing unit (CPU) 11, a memory controller hub (MCH) 12, a main memory 13, a graphics processing unit (GPU) 14, an LCD 15, an I/O Controller Hub (ICH) 16, a sound controller 17, and a speaker 18.

The CPU 11 is a processor for controlling the operation of the PC 1, and executes various programs stored in the main memory 13.

The MCH 12 operates as a bridge device for connecting the CPU 11 with the ICH 16, and simultaneously operates as a memory controller for performing access control for the main memory 13. The MCH 12 has also the function of performing communication with the GPU 14.

The GPU 14 is a display controller for controlling the LCD 15, and has a video generating section 141 for generating video data to be displayed by various programs executed by the CPU 11. Further, the GPU 14 has, in addition to the video generating section 141, an audio generating section (1) 142 for generating audio data to be similarly outputted by various programs executed by the CPU 11.

The ICH 16 controls various I/O devices in the PC 1. The ICH 16 has also the function of performing communication with the GPU 14 and the sound controller 17.

The sound controller 17 is a sound generator device and has an audio generating section (2) 171 for generating audio data to be outputted by various programs executed by the CPU 11. Further, the sound controller 17 has the function of outputting audio to the speaker 18.

The PC 1 having such a configuration is provided with a DisplayPort terminal (DP terminal) 3A to which a DisplayPort monitor 2a or 2b is to be connected through a DisplayPort cable (DP cable) 3 according to the DisplayPort standard. In place of outputting to the LCD 15, the GPU 14 can also output the video data generated by the video generating section 141, to the outside through the DP terminal 3A. That is, the user can watch the output image of the notebook PC 1 on the LCD 15 as well as on the DisplayPort monitor 2a or 2b connected through the DP cable 3.

Further, the DP cable 3 connected to the DP terminal 3A can transmit audio data together with video data. Further, the GPU 14 has also the function of outputting the audio data generated by the audio generating section (1) 142, to the outside through the DP terminal 3A. On the other hand, in the DisplayPort compatible monitor, the audio output is optional. Here, it is assumed that the DisplayPort monitor 2a has an audio output function (has a speaker 22) and that the DisplayPort monitor 2b does not has an audio output function (does not have a speaker 22).

Then, the notebook PC 1 can appropriately switch the audio output destination in accordance with the situation as follows. That is, when the DisplayPort monitor 2a or 2b is connected, the video output destination is switched from the LCD 15 to the DP terminal 3A, that is, to the monitor 21 of the DisplayPort monitor 2a or 2b. At the same time, in case of the DisplayPort monitor 2a having an audio output function, the audio output destination is also switched from the speaker 18 to the DP terminal 3A, that is, to the speaker 22 of the DisplayPort monitor 2a. In contrast, in case of the DisplayPort monitor 2b not having an audio output function, the audio output destination is maintained at the speaker 18. This feature is described below in detail.

It is set forth that each DisplayPort compatible monitor has identification information referred to as EDID (Extended Display Identification Data). In order to store the EDID, the DisplayPort monitor 2a or 2b has a ROM (Read Only Memory) 23. The EDID has a VESA block of 128 bytes and a CEA block which is an optional extended portion. The third byte in the CEA block includes a record as to whether audio input is available. Thus, when a DisplayPort compatible monitor is connected, the notebook PC 1 acquires the EDID, then refers to the CEA block in the EDID, and then controls whether the audio output destination is to be switched from the speaker 18 to the DP terminal 3A.

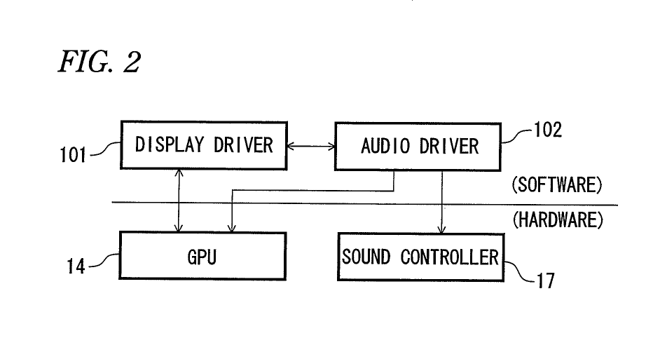

FIG. 2 is a functional block diagram showing the video output and the audio output of the notebook PC 1.

The display driver 101 is a program for managing the control of the video output in the notebook PC 1, and drives and controls the GPU 14 in response to requests from various programs executed by the CPU 11. On the other hand, the audio driver 102 is a program for managing the control of the audio output in the notebook PC 1, and drives and controls the GPU 14 and the sound controller 17 in response to requests from various programs executed by the CPU 11. That is, the display driver 101 and the audio driver 102 provide interfaces for allowing the various programs composed of software to cause the GPU 14 and the sound controller 17 composed of hardware to performed desired operation. Further, the display driver 101 and the audio driver 102 of the notebook PC 1 have a communication function used for cooperating with each other.

When a DP cable 3 is attached to the DP terminal 3A and hence the DP terminal 3A is electrically connected to a DisplayPort compatible monitor, the GPU 14 detects the connection with the DisplayPort compatible monitor and then notifies the situation to the display driver 101. Then, when receiving this notification, the display driver 101 acquires through the GPU 14 the EDID stored in the ROM 23 of the DisplayPort compatible monitor 2a or 2b.

When acquiring the EDID through the GPU 14, the display driver 101 transfers the acquired EDID to the audio driver 102. At that time, the display driver 101 notifies to the GPU 14 an instruction of switching the video output destination from the LCD 15 to the DP terminal 3A.

On the other hand, the audio driver 102 having received the EDID from the display driver 101 refers to the CEA block in the EDID so as to check whether the audio data output is supported.

Here, in case of a monitor (like the DisplayPort compatible monitor 2b) not having a speaker 22, no CEA block is recorded in the EDID. In this case, the audio driver 102 concludes that an audio output is not supported.

Then, when it is determined that an audio output is supported in the CEA block, the audio driver 102 switches the generation of audio data by the audio generating section (2) 171 of the sound controller 17 to the generation of audio data by the audio generating section (1) 142 of the GPU 14, and then switches the audio output destination from the speaker 18 to the DP terminal 3A. In contrast, when it is determined that an audio output is not supported in the CEA block, the audio driver 102 performs nothing. As a result, the audio output destination is maintained at the speaker 18.

By virtue of the above-mentioned principles, when the DisplayPort monitor 2a shown in FIG. 1 is connected, switching is performed automatically such that the audio is outputted from the speaker 22 of the DisplayPort monitor 2a. In contrast, when the DisplayPort monitor 2b is connected, the audio is maintained to be outputted from the speaker 18 of the notebook PC 1. Thus, when the DisplayPort monitor 2b is connected, in linkage with the switching of the video output destination, the audio data is also switched such as to be outputted through the DP terminal 3A so that a situation is avoided that the audio is not outputted from anywhere.

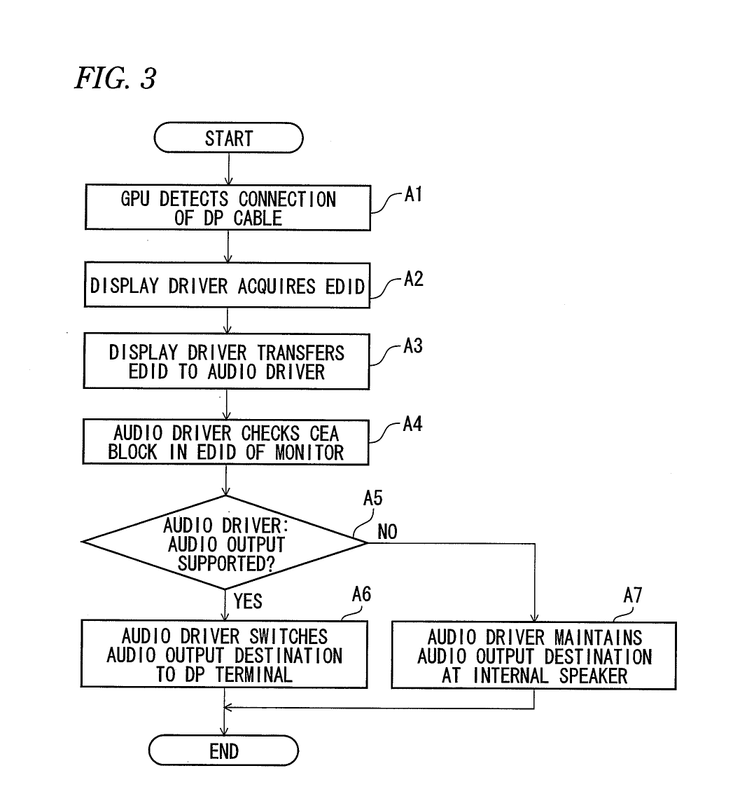

FIG. 3 is a flowchart showing an operation procedure of audio output control executed by the notebook PC 1.

When a DP cable 3 is connected to the DP terminal 3A, the GPU 14 detects the situation (Step A1), and then notifies the situation to the display driver 101. When receiving this notification, the display driver 101 acquires through the GPU 14 the EDID from the DisplayPort compatible monitor serving as a connection counterpart (Step A2).

The display driver 101 transfers the acquired EDID to the audio driver 102 (Step A3). Then, the audio driver 102 checks the CEA block in the EDID received from the display driver 101 (Step A4) so as to determine whether the audio output is supported by the DisplayPort compatible monitor serving as a connection counterpart (Step A5).

When it is determined that the audio output is supported in the CEA block (YES at Step A5), the audio driver 102 switches the audio output destination from the speaker 18 (via the sound controller) to the DP terminal 3A (via the GPU 14) (Step A6). In contrast, in case of the absence of an agreeing audio data format (NO at Step A5), the audio driver 102 maintains the audio output destination at the speaker 18 (Step A7).

As such, the notebook PC 1 realizes appropriate control of switching of the audio output destination in a situation that an external monitor is connected.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a speaker;
a sound controller configured to generate audio data and to output the audio data through the speaker;
an audio driver configured to control the sound controller;
a connection terminal configured to connect to a cable and to simultaneously transmit video data and audio data to an external monitor; and
an identification acquisition module configured to acquire identification information from the external monitor when the external monitor is connected to the connection terminal, the identification information comprising information as to whether the external monitor comprises an audio output function;
wherein the audio driver is configured to determine whether the external monitor comprises the audio output function based on the identification information;
wherein, if the audio driver determines that the external monitor comprises the audio output function, the audio driver is configured to switch an output destination of the audio data to the connection terminal; and
wherein, if the audio driver determines that the external monitor does not comprise the audio output function, the audio driver is configured to switch the output destination of the audio data to the speaker.

2. The apparatus of claim 1, further comprising:
a graphics processing unit (GPU) configured to output video data through the connection terminal;
wherein the identification acquisition module is provided in a display driver configured to control the GPU.

3. The apparatus of claim 2,
wherein the GPU is configured to generate audio data to be output from the connection terminal, and
the audio driver is configured to switch the output destination of the audio data from the speaker to the connection terminal by switching from the sound controller to the GPU.

4. The apparatus of claim 1,
wherein the connection terminal comprises a DisplayPort terminal configured to connect to a cable according to a DisplayPort standard.

5. The apparatus of claim 4,
wherein the identification information comprises extended display identification data (EDID).

6. The apparatus of claim 5,
wherein the audio driver is configured to determine whether the external monitor comprises the audio output function based on a Consumer Electronic Association (CEA) block in the EDID.

7. A switching control method for an audio output destination in an information processing apparatus, wherein the information processing apparatus comprises:
a speaker;
an audio driver configured to control an audio output; and
a connection terminal configured to connect to a cable and to simultaneously transmit video data and audio data to an external monitor, the method comprising:
acquiring identification information from the external monitor when the external monitor is connected to the connection terminal, the identification information comprising information for determining whether an audio output function is supported;
determining whether the external monitor comprises the audio output function based on the identification information;
switching an output destination of the audio data to the connection terminal if it is determined that the external monitor comprises the audio output function; and
switching the output destination of the audio data to the speaker if it is determined that the external monitor does not comprise the audio output function.
